(19) United States
(12) Patent Application Publication
(10) Pub. No.: US 2025/0272914 A1
(43) Pub. Date: Aug. 28, 2025

(54) SYSTEM AND METHOD FOR SENSOR PLACEMENT, CONFIGURATION AND TRACKING

(71) Applicant: 4Liberty, San Diego, CA (US)

(72) Inventors: Mychail Vanwyk, Carlsbad, CA (US); John Domenichelli, San Diego, CA (US)

(21) Appl. No.: 19/062,937

(22) Filed: Feb. 25, 2025

Related U.S. Application Data
(60) Provisional application No. 63/558,114, filed on Feb. 26, 2024.

(51) Int. Cl. G06T 17/00; G06F 30/13; G06F 111/18; G06T 15/20; G06T 19/00; H04N 7/18; H04N 17/00; H04N 23/66

(52) U.S. Cl. CPC G06T 17/00; G06F 30/13; G06T 15/205; G06T 19/006; H04N 7/183; H04N 17/002; H04N 23/66; G06F 2111/18; G06T 2210/04

(57) ABSTRACT

A system and method for placing and configuring physical security sensors & barriers, are described. The system generates and analyzes a three-dimensional model of a customer's premises using non-imaging sensors to determine optimal sensor placement. Based on customer requirements, the system distributes sensor models within the premises while accounting for environmental obstructions, coverage gaps, and redundancy minimization. An extended reality (XR) interface allows users to visualize and refine sensor configurations before deployment. The system integrates AI-driven analytics to optimize surveillance coverage, adjust sensor orientations dynamically, and generate detailed reports outlining sensor locations and configurations. The sensor stand transmits real-time data to the system for continuous monitoring, predictive maintenance, and security threat analysis. The system enhances security planning by reducing design time, installation costs, preventing post-deployment modifications, and ensuring comprehensive monitoring coverage across diverse environments, including commercial, industrial, and critical infrastructure sites.

### CROSS-REFERENCE TO RELATED APPLICATIONS

This application claims priority under 35 U.S.C. § 119 (e) from U.S. Provisional Patent Application No. 63/558,114, filed Feb. 26, 2024.

### BACKGROUND

Known physical & electronic security system design rely heavily on manual planning, site surveys, and static blueprints to determine the placement of surveillance cameras, motion detectors, access control systems, and other security infrastructure. Such approach often results in inefficiencies, coverage gaps, over-specification, under-specification, and costly post-installation adjustments, and lacks the ability to dynamically simulate real-world security scenarios before deployment. Additionally, security professionals must manually assess line-of-sight obstructions, sensor coverage overlaps, and compliance with industry regulations, making the process labor-intensive and prone to human error. The lack of automated security system design validation can lead to vulnerabilities, increased false alarms, higher long-term operational and maintenance costs, and costly change orders.

Some systems for generating proposed physical security system designs or layouts generally provide customers a limited idea of what a customer's total monitoring presence will be prior to a costly installation process. For this reason, deployment of monitoring sensors often unintentionally leave areas or zones of a physical premises uncovered and vulnerable for intrusion without detection or conversely provides too much detection, increases: false alarms, system costs, operation & maintenance costs, and lifecycle upgrade costs.

### SUMMARY

Accordingly, some embodiments include systems and methods for helping to design and field a surveillance system for a customer are described. A method is described and includes: receiving a three dimensional model of a customer premises generated at least in part by one or more non-imaging sensors; receiving premises coverage requirements; autonomously distributing a plurality of sensor models within the three dimensional model of the customer premises in a configuration that satisfies the premises coverage requirements; and generating one or more reports describing the locations and configurations of the plurality of sensor models relative to the customer premises & specifications.

Some embodiments provide a system and method for automating the placement and configuration of security sensors within a physical environment. The system uses LiDAR, 3D modeling, AI-based sensor placement algorithms, and parametric templates to optimize security coverage. In some embodiments, the generated security system design includes visual representations, cost estimates, and regulatory compliance validation.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is noted, however, that the appended drawings illustrate only some aspects of this disclosure and the disclosure may admit to other equally effective embodiments.

To facilitate understanding, identical reference numerals have been used, where possible, to designate identical elements that are common to the figures. It is contemplated that elements and features of one embodiment may be beneficially incorporated in other embodiments without further recitation.

FIG. 1 depicts a schematic of a system for sensor placement and tracking, shown as a top view of an exemplary customer premises, in accordance with some embodiments;

FIGS. 2A-2C depict schematics of a three-dimensional premises model for the fields of view associated with a sensor stand, in accordance with some embodiments;

FIG. 3 shows a page of an exemplary physical security proposal that depicts various features of a sensor stand, in accordance with some embodiments;

FIG. 4 depicts a schematic of a model of an interior building structure created from a LiDAR point cloud, in accordance with some embodiments;

FIG. 5 shows a block diagram representing inputs and output for a sensor placement system; and

FIG. 6 depicts a schematic of a system for sensor placement and tracking, in accordance with some embodiments.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more embodiments herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Embodiments described as being implemented in hardware should not be limited thereto, but can include embodiments implemented in software, or combinations of software and hardware, and vice-versa, as will be apparent to those skilled in the art, unless otherwise specified herein. In the exemplary embodiments described herein, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The embodiments described herein relate generally to systems and method for sensor placement configuration and tracking, which may be implemented in a physical security environment, such as place of business, government building, or school. For example, some systems for generating proposed physical security system designs or layouts generally provide customers a limited idea of what a customer's total monitoring presence will be prior to a costly installation process. For this reason, deployment of monitoring sensors often unintentionally leave areas or zones of a physical premises uncovered and vulnerable for intrusion without detection or conversely provides too much detection, increases false alarms, increases system costs, operation & maintenance costs and lifecycle upgrade costs. Accordingly the embodiments described below include advantageous features in the design, deployment, and integration of physical & electronic security systems by modifying and building upon techniques implementing Virtual Design and Construction (VDC) and Building Information Modeling (BIM) techniques. As utilized herein, BIM and three-dimensional (3D) BIM may be used interchangeably.

Some embodiments describe below are applicable for planning, designing, and managing, complex infrastructure projects by providing detailed digital representation of a structure, allowing for enhanced design coordination, clash detection, and spatial accuracy. Some embodiments may focuses on the geometric and informational aspects of a project, extending beyond by incorporating scheduling, cost estimation, and operational lifecycle management, transforming static models into dynamic, data-driven simulations. By integrating multi-dimensional modeling, including 3D spatial visualization, 4D construction sequencing, and 5D cost forecasting, the embodiments described herein enable stakeholders to anticipate design conflicts, optimize resource allocation, and ensure compliance with regulatory requirements before physical construction begins.

The system and methods described enhances traditional security system design and planning approaches by leveraging digital simulations to optimize sensor placement, eliminate blind spots, and ensure regulatory compliance. Unlike conventional security design processes that rely on manual assessments and static blueprints, the embodiments herein integrates artificial intelligence, machine learning, and real-time modeling to create adaptable, data-driven security layouts. Such technology allows for automated clash detection, cost-efficient system planning, and extended reality (XR) visualization, ensuring that security installations are strategically optimized before deployment. For example, in some embodiments, by combining detailed spatial modeling with advanced project management capabilities, described below, security system planning can be transformed into a more efficient, accurate, and scalable process, reducing costs while enhancing protection and operational resilience.

For example, some existing design systems configured for laying out physical & Electronic security monitoring often only make rough estimates as to actual sensor coverage on account of not having the capability to accurately map a potential customer's premises, apply sensor coverage for those sensors to the map of the potential customer's physical premises and then make automation intelligent choices as to the ideal placement of sensors to achieve a customer's desired security design goals. As a result, customers relying on the existing security design systems often end up with a security system that includes undesirable coverage such as an over specified & under specified security system which causes a vendor to make multiple adjustments, change orders and service tickets to their sensors to achieve the desired security coverage.

The embodiments herein model a customer's premises using three dimensional mapping techniques and then determine sensor positions to distribute sensors throughout the modeled premises to achieve a customer's coverage requirements. Once the modeling process is complete, a potential customer is able to view their premises and precise sensor field of view visualizations indicating where a particular set of sensors is able and not able to provide coverage. These techniques are applicable and compatible with a large variety of different premises including electrical utility designs (e.g., electrical transmission, electrical distribution, substations, battery energy storage systems, hydroelectric facilities) and commercial facilities (e.g., medical facilities, hotels, emergency service buildings, military installation buildings, government entities, and the like)

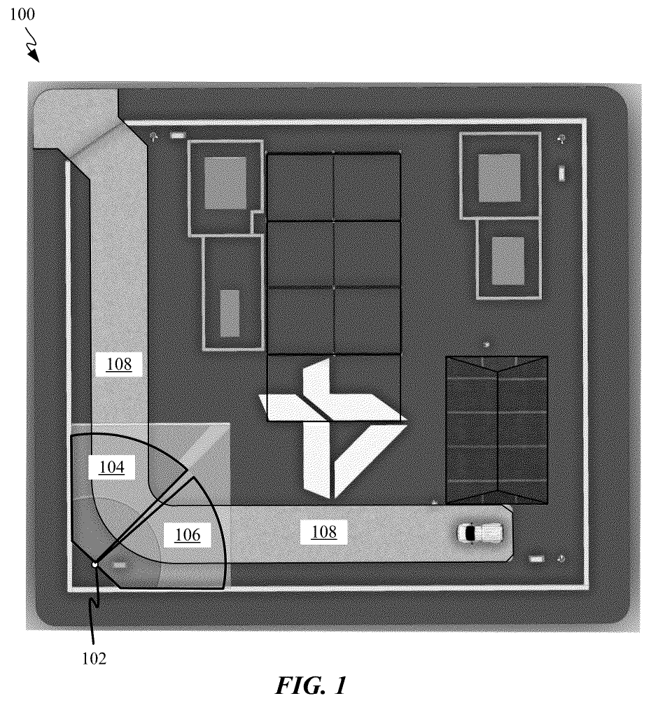

Referring now to FIG. 1, FIG. 1, depicts a top view of system 100 deployed at an exemplary customer premise, in accordance with some embodiments. System 100 includes fields of view 104 and 106 associated with sensor stand 102. Sensor stand 102 includes two fields of view from two distinct sensors that help monitor incoming and outgoing traffic travelling along road. In some embodiments, system 100 may incorporate a sophisticated, AI-driven security deployment that optimizes sensor placement, coverage analysis, intrusion detection, and regulatory compliance. By leveraging real-time 3D modeling, AI-powered clash detection, and multi-sensor fusion technology, the methods employed by system 100 eliminates surveillance blind spots, enhances operational security, and ensures comprehensive monitoring of vehicular movement and intrusion threats within the customer premise, which is discussed in detail below.

In some embodiments, first field of view 104, associated with a sensor mounted on sensor stand 102, may be configured to monitor incoming traffic moving along road 108 & Intrusions located at the perimeter fence/wall of the premises. As shown in FIG. 1, sensor stand 102 is strategically positioned along road 108 to provide optimized surveillance coverage. Sensor stand 102 incorporates multiple fields of view 104 and 106, each representing distinct sensor monitoring zones that are configured to track and analyze incoming and outgoing vehicular traffic, as well as potential intrusion attempts at the perimeter fence or wall of the premises.

In some embodiments, first field of view 104 is associated with a sensor mounted on sensor stand 102 that is configured to monitor incoming traffic moving along road 108. This sensor is designed to capture high-resolution images of vehicle drivers, vehicle license plates, and other identifying details to ensure proper monitoring and verification of all vehicles entering the premises. Additionally, the sensor's placement and configuration enable automated facial recognition and vehicle classification, improving security personnel's ability to track individuals and vehicles accessing the facility. The first field of view 104 also encompasses portions of the perimeter fence or wall, ensuring that unauthorized attempts to bypass or breach security checkpoints are detected in real time.

Similarly, second field of view 106 is configured to monitor outbound traffic along road 108. This sensor is responsible for capturing details of vehicles exiting the premises, including driver identity verification and potential unauthorized access attempts. Security breaches can sometimes occur when unauthorized vehicles attempt to exit a secure facility after gaining illicit entry, making outbound monitoring equally critical. The second field of view 106 also extends coverage to portions of the perimeter fence or wall, reinforcing security along potential intrusion points and blind spots. In this configuration, the combination of fields of view 104 and 106 creates a multi-layered security approach where vehicles are monitored both upon entry and exit, enhancing tracking capabilities and reducing potential security vulnerabilities.

While FIG. 1 provides an overview of the surveillance coverage, FIG. 1 does not inherently reveal whether there are gaps in the coverage beneath the fields of view 104 and 106. Such gaps, if unaccounted for, could allow unmonitored vehicular entry or unauthorized access to road 108. In some embodiments, these coverage blind spots are mitigated by automated clash detection algorithms, which analyze sensor placement against environmental factors such as buildings, vehicles, vegetation, and physical obstructions. For example, vegetation, designated vehicle parking locations, building structures, or other infrastructure may partially obscure camera views or sensor-detection devices, reducing the effectiveness of the sensor deployment. In response, system 100 may dynamically reposition sensor stand 102 or adjust the angles of the sensors to maintain optimal coverage while minimizing obstructions.

In some embodiments, sensor stand 102 may be equipped with LiDAR-based environmental scanning technology that enables the system to generate a real-time 3D BIM of the premises. By continuously analyzing the spatial environment and sensor coverage zones, the system can identify and resolve potential blind spots, ensuring seamless integration with automated security monitoring protocols. Additionally, machine learning algorithms may process real-time surveillance footage to detect patterns of movement, unauthorized behaviors, and anomalies in the baseline of a given environment, thereby optimizing the security system's effectiveness.

Another advantageous consideration in sensor placement is regulatory compliance. In some embodiments, the system ensures that all sensors deployed at sensor stand 102 conform to industry regulations such as NERCIP-014 (North American Electric Reliability Corporation Critical Infrastructure Protection), FERC (Federal Energy Regulatory Commission), and other security policies and regulations. This compliance validation ensures that security monitoring systems adhere to legal and operational standards, particularly in high-security environments such as power substations, government facilities, military installations, and commercial properties requiring elevated security measures.

Beyond intrusion detection and vehicle monitoring, sensor stand 102 may also serve additional multi-functional security purposes. In some configurations, it can integrate with biometric access control systems, (LPR) license plate readers, RFID-based vehicle tracking systems, or real-time incident response alerts. The ability to process and correlate multiple data sources-video feeds, thermal imaging, motion sensors, and access control logs-enhances the overall intelligence of the security system.

In some embodiments, the data captured from sensor stand 102 may be seamlessly integrated into a centralized security management platform, allowing real-time visualization, threat assessment, and response coordination. Security personnel can utilize extended reality (XR) visualization tools, including augmented and (VR) virtual reality simulations, to interactively adjust sensor placements, refine security configurations, and preemptively identify vulnerabilities before physical installations occur, which is described in detail further below. This digital twin simulation capability ensures that security coverage is optimized while minimizing costly infrastructure modifications post-installation.

The scalability of the system also allows for the expansion of additional sensor stands across multiple entry and exit points, high-risk zones, and sensitive areas within the premises. Each additional sensor stand can be dynamically configured to work in coordination with new or existing security infrastructure, ensuring that security personnel maintain full situational awareness and control over the entire premises.

In some embodiments, system 100 utilizes a combination of 3D BIM mapping techniques, and sensor placement automation to create a comprehensive security system design for a customer's premises 100. In some embodiments, system 100 may employ LiDAR (Light Detection and Ranging) sensors and/or other non-imaging sensors, such as time-of-flight sensors or stereo vision cameras, to generate an accurate 3D BIM of the customer premises.

In some embodiments, this LiDAR-based modeling process is performed either by surveyors conducting a site walkthrough or by using aerial platforms that scan the premises from above. This approach allows for the detection and classification of security infrastructure, including existing surveillance devices, access control points, and intrusion detection systems. The system is further capable of automatically converting these data points into a parametric BIM, allowing for precise gap analysis and identification of vulnerabilities.

In some embodiments, once the 3D BIM is constructed, the sensor placement system distributes a plurality of sensor models within the virtual premises. The system determines the placement of sensor stand 102, which includes distinct fields of view 104 and 106 covering road 108, ensuring that the entire perimeter of the premises is under surveillance. The system dynamically analyzes obstructions, detects blind spots, and adjusts field-of-view configurations to maximize security effectiveness.

By utilizing advanced parametric modeling, the system ensures that each sensor matches real-world installation specifications, reducing discrepancies between virtual design and physical deployment. Customers are provided with an automated security system layout plan that considers optimal coverage, budget constraints, and existing physical barriers to produce a system that is both efficient and cost-effective.

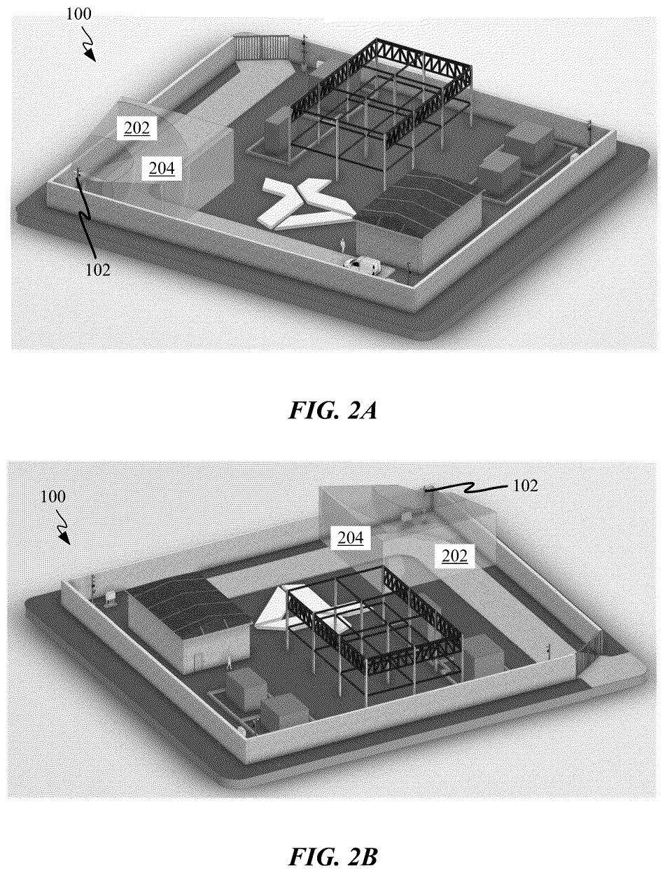

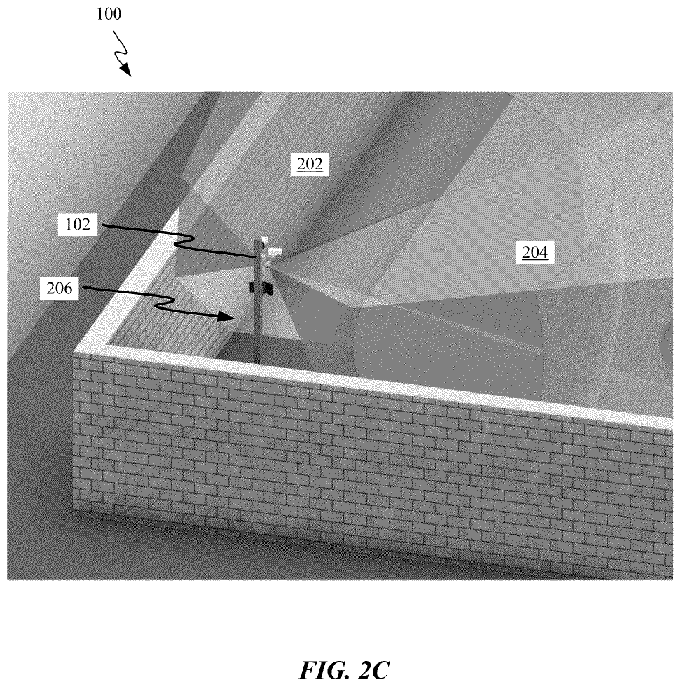

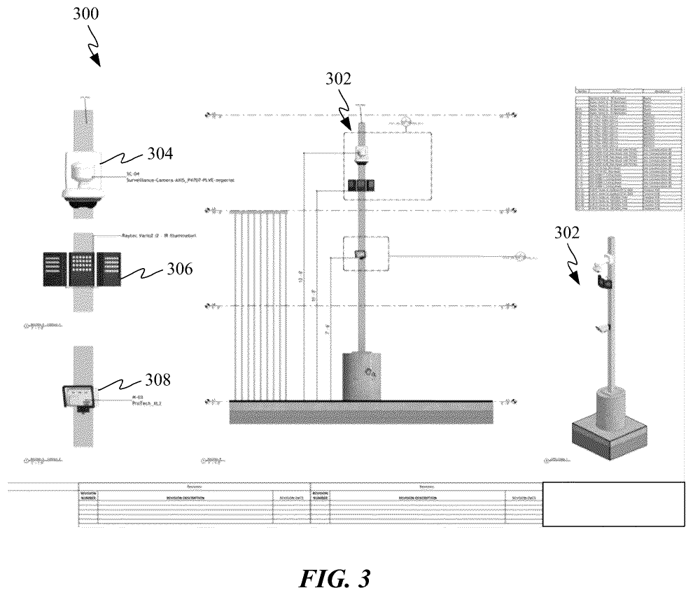

Referring now to FIGS. 2A-2C in conjunction with FIG. 3, FIG. 2A illustrates preparation of a 3D BIM of the premises, which can allow for the fields of view associated with sensor stand 102 to be viewed at multiple angles. In particular, the close-up view in FIG. 2C highlights a size and location of a gap in coverage near the base of sensor stand 102 that is not visible from a top-down view. In some embodiments, visualizations like these can also illustrate how a top side of a structure can be too tall for its top surface to be covered by a depicted sensor field of view. This can be problematic in the event any high value equipment is located atop such a structure. It should be noted that this type of visualization allows display of only a single field of view 306 for sensor stand 102 to allow a user or customer to focus on performance of a particular sensor or sensors.

The combination of FIGS. 2A-2C and FIG. 3 demonstrate how system 100 leverages 3D BIM, AI-driven optimization, and parametric design principles to create efficient, scalable, and highly effective surveillance solutions. By utilizing advanced simulation techniques, real-time clash detection, and dynamic sensor placement strategies, system 100 ensures maximum security coverage while minimizing costs, false alarms, and installation inefficiencies. Discussed in further detail below, the integration of infrared illumination, AI-enhanced surveillance, and automated security response mechanisms further strengthens the resilience and adaptability of deployed security infrastructure.

For example, by applying machine learning-based predictive modeling, system 100 continuously refines and improves security configurations over time, ensuring that evolving threats, environmental changes, and compliance requirements are accounted for dynamically. The automated security proposal generation capabilities further streamline the deployment process, making it possible to implement comprehensive, data-driven security solutions across various facility types and risk profiles.

Referring back to FIG. 2A-2C, FIGS. 2A-2C, these figures illustrate the 3D BIM of sensor placement within the customer premises 100, with a focus on the fields of view 202 and 204 associated with sensor stand 102. Unlike the top-down view in FIG. 1, these figures provide multiple angles and perspectives to highlight how the system dynamically calculates, optimizes, and visualizes surveillance coverage to ensure a comprehensive security system design.

In FIG. 2A, sensor stand 102 is positioned along the perimeter of customer premises 100, with its field of view 202 covering a portion of the external perimeter while field of view 204 extends further into the secured area. Such VDC virtual design and construction methodology and visualization provides security designers with a more accurate representation of real-world sensor placement, ensuring that coverage areas are aligned with both security objectives and physical constraints such as walls, fences, vegetation, and terrain obstructions. By incorporating environmental modeling, the system can predict whether obstructions-such as buildings, storage units, or structural reinforcements-interfere with sensor effectiveness.

Similarly, FIG. 2B presents an alternate angle of the same surveillance configuration, emphasizing how the elevated perspective of sensor stand 102 allows for broader coverage while still encountering potential obstructions. This figure particularly highlights how different security zones within customer premises 100 may require adjustments to sensor height, angle, and field of view settings. The system utilizes real-time clash detection algorithms to determine whether the proposed sensor placements result in obstructed views, overlapping coverage, or blind spots that could compromise security monitoring effectiveness.

A closer inspection of the sensor configuration is provided in FIG. 2C, which zooms in on sensor stand 102 and its associated surveillance coverage zones. This close-up view demonstrates how the base of the sensor field of view 202 and 204 may have coverage gaps at 206 due to device placement and configuration. This is a critical consideration in security system design, as intruders may exploit unmonitored regions near walls, fences, or structural barriers. To address these vulnerabilities, the system employs AI-driven field-of-view optimization techniques, which adjust sensor tilt, rotation, and height parameters to maximize coverage while minimizing obstructions.

In some embodiments, the sensor placement system integrates LiDAR scanning technology to generate high-precision 3D BIM environmental models, allowing security professionals to simulate sensor coverage scenarios dynamically. Additionally, extended reality (XR) visualization tools may be used to virtually test sensor effectiveness in various lighting conditions, weather scenarios, and potential security breach situations. By providing a real-time 3D BIM representation of sensor field interactions, the system ensures that no surveillance blind spots remain undetected before physical installation occurs.

Furthermore, the automated clash detection and optimization capabilities of system 100 are designed to ensure that sensors do not overlap unnecessarily, leading to redundant monitoring or excessive false alarms. The AI-driven model can dynamically redistribute sensor placements to achieve the most effective security coverage with the fewest number of sensors, ultimately reducing installation costs and ongoing operational and maintenance expenses.

By leveraging machine learning algorithms, the system continuously improves sensor deployment strategies by analyzing historical breach data, environmental factors, and real-world sensor performance metrics. These predictive analytics allow the system to refine security configurations dynamically over time, ensuring adaptive surveillance that evolves with changing security needs.

In some embodiments, the sensor placement system integrates multi-angle 3D BIM visualization to analyze sensor positioning, field-of-view accuracy, and real-time environmental interactions. System 100 utilizes computational analysis to detect obstructions and coverage gaps, ensuring that sensor stand 102, with its associated fields of view 202 and 204, is properly aligned with the customer's security objectives. For example, by merging blueprint-based modeling with LiDAR-generated 3D BIM scans, system 100 creates an accurate spatial representation of the premises, even in cases where portions of the premises are under construction or inaccessible during a walkthrough. This hybrid approach ensures that the security system design is modeled as accurately as possible, incorporating both completed and uncompleted structures.

In some embodiments, through real-time clash detection algorithms, system 100 evaluates whether walls, perimeter fences, or storage structures obstruct surveillance sensors. By overlaying sensor coverage heat maps within the virtual model, customers and security professionals can detect inefficiencies, identify optimal placements, and modify system configurations before finalizing the installation.

In some embodiments, system 100 incorporates extended reality (XR) headset integration, allowing security planners to virtually experience sensor coverage from multiple angles. This immersive experience enables live adjustments to camera angles, sensor stand heights, and infrared illuminator positioning, ensuring that sensor overlaps and gaps are minimized.

The XR features of system 100 further allows customers to simulate security incidents, such as an intruder attempting to bypass monitored zones, providing a real-world assessment of how surveillance cameras and motion sensors respond to potential threats. By using AI-driven optimization, the system continuously refines sensor placements based on predicted intrusion paths, environmental conditions, and building modifications over time.

Referring now to FIG. 3, FIG. 3 depicts a detailed security system 100 in accordance with some embodiments, and provides a technical overview of sensor stand 302, including its components, placement parameters, and surveillance functionalities. As shown in FIG. 3, sensor stand 302 serves as a multi-functional surveillance unit, integrating multiple security components to maximize monitoring efficiency. In some embodiments, surveillance camera 304 may be mounted at an elevated height, allowing for broad-range visual monitoring of the premises. In some embodiments, camera 304 may be equipped with high-resolution imaging, AI-powered facial recognition, and/or motion-tracking capabilities, enabling real-time identification and anomaly detection.

In some embodiments, beneath surveillance camera 304, an infrared (IR) illuminator 306 may be incorporated into the sensor stand, significantly enhancing the performance of night-vision and low-light monitoring systems. Infrared illumination ensures that security cameras maintain clear visibility in total darkness, preventing intruders from exploiting nighttime conditions to bypass detection. The inclusion of adaptive IR intensity control allows the system to adjust illumination levels dynamically, reducing glare, overexposure, and unnecessary light pollution.

In some embodiments, motion detector 308 may be positioned to provide proactive threat detection capabilities. Such sensor (308) may be configured to trigger automated security alerts and access control lockdowns upon detecting unauthorized movement. The motion detector's integration with AI-based behavioral analysis software enables real-time differentiation between legitimate personnel movements and potential security threats, reducing false alarms while enhancing security response accuracy.

FIG. 3 includes precise measurement specifications, defining the recommended height, viewing angles, and operational parameters of sensor stand 302, in accordance with some embodiments. This ensures that installation teams and security planners have standardized configurations for deployment, minimizing errors and ensuring consistency across multiple premises.

In some embodiments, all sensor configuration details are stored within a parametric template, allowing security professionals to quickly generate security plans for various facility layouts. This automation significantly reduces the time and effort required for manual security assessments, accelerating project timelines and improving overall efficiency.

Furthermore, sensor stand 302 facilitates remote system monitoring, automated software updates, and real-time data analytics. For example, in some embodiments, system 100 can be configured to send alerts to security personnel via mobile applications, command centers, or automated response protocols, ensuring rapid situational awareness and decision-making.

Additionally, FIG. 3 may correspond to an overlay implemented on a graphical user interface (GUI) (e.g., display device 610) that can be overlaid onto digital premises maps, satellite imagery, or BIMs to provide security planners with a comprehensive visualization of coverage zones. Such approach enables proactive identification of security vulnerabilities and allows planners to make real-time adjustments before physical deployment.

In some embodiments, advanced AI simulation tools are integrated into the security proposal generation process, enabling planners to simulate various security breach scenarios and optimize sensor placements dynamically. In some embodiments, system 100 may also utilize predictive analytics to suggest future system upgrades, equipment maintenance schedules, and component lifecycle management recommendations, ensuring that security infrastructure remains operationally effective over time.

In some embodiments, system 100 provides a detailed overview of a sensor stand configuration, including its precise placement, viewing angles, and associated components. The sensor stand 302 comprises a primary surveillance camera 304, an infrared (IR) illuminator 306, and a motion detector 308, ensuring that multiple layers of security are accounted for within the installation plan.

System 100's ability to determine or retrieve pre-configured sensor stand models from a standardized template allows for efficient scalability and customization based on customer requirements. In some instances, a customer may specify areas of high security concern, such as ingress and egress points, perimeter fences, and high-value asset zones. The system adjusts sensor placement dynamically, factoring in budgetary constraints, optimal field-of-view coverage, and required redundancy levels.

For installations requiring varying levels of surveillance coverage, the system offers pre-configured sensor stands designed to monitor different sector angles, including 90-degree, 180-degree, 270-degree, and full 360-degree coverage. Security planners can compare different sensor models in real time, optimizing for cost, coverage, and effectiveness.

For example, by integrating with BIM and security industry databases, the system keeps an updated repository of sensor specifications, ensuring that security system designs incorporate the latest available technology. This automated update mechanism reduces errors, enhances installation efficiency, and provides customers with a highly tailored security solution.

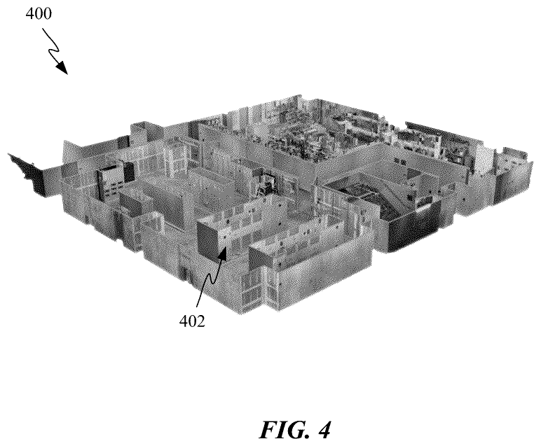

Referring now to FIG. 4, FIG. 4 demonstrates how advanced LiDAR-based modeling enhances security system design, sensor placement accuracy, and surveillance effectiveness, in accordance with some embodiments. As discussed in detail below, the ability to dynamically map obstructions, optimize surveillance coverage, and integrate AI-driven analytics transforms traditional security planning into a fully automated, data-driven process, ensuring seamless, adaptive, and highly effective protection of physical assets and personnel.

FIG. 4 depicts an interior three-dimensional (3D) model 400 of a building structure. In some embodiments, model 400 may be generated using a LiDAR-based point cloud system. Model 400 provides a high-resolution spatial representation of the building's architectural layout, structural elements, and interior features, offering a detailed mapping of walls, rooms, partitions, furniture, and industrial equipment. The LiDAR-based approach enables accurate spatial analysis, which is essential for intelligently deploying and optimizing security sensors within complex environments.

In some embodiments, the sensor placement system utilizes point cloud data to identify potential obstructions and structural barriers that may affect security system effectiveness. For instance, locker stand 402 represents a physical obstruction within the modeled premises 400, which may impact the fields of view of surveillance cameras, motion detectors, or other security sensors deployed within the environment. System 100, via model 400, dynamically analyzes the positioning and height of such obstructions to determine whether a particular sensor's line of sight is blocked, partially obstructed, or fully effective in the given spatial configuration.

In some embodiments, LiDAR-generated model 400 captures millions of spatial coordinates with sub-centimeter accuracy, allowing the security system to construct a precise digital twin of the physical premises. This high-fidelity mapping enables automated clash detection, ensuring that security sensors are placed in optimal positions to eliminate blind spots while maintaining efficient coverage without unnecessary redundancy. Additionally, the system can simulate real-world surveillance scenarios, including low-light conditions, physical obstructions, and personnel movement patterns, providing a comprehensive pre-installation assessment of security effectiveness.

By leveraging AI-driven spatial analytics, the sensor placement system can dynamically adjust and refine sensor configurations based on real-time 3D spatial data. This allows security planners to proactively address potential surveillance challenges, such as obstructed fields of view due to furniture, machinery, or structural components, interference with access control sensors caused by high-traffic areas or physical barriers, and inefficient sensor placement leading to excessive overlap, false alarms, or insufficient security coverage.

In some embodiments, LiDAR data is integrated with BIM frameworks, enabling cross-referencing of digital blueprints, architectural plans, and security layouts. This integration allows security teams to visualize sensor placements within the broader architectural context, ensuring that all physical security components (such as turnstiles, vehicle gates, pedestrian gates) and electronic security components (such as cameras, infrared sensors, motion detectors, and access control systems) are positioned in alignment with both security objectives and facility design constraints.

Furthermore, machine learning algorithms incorporated within the system continuously analyze and refine sensor placements over time. By processing historical surveillance data, security breach patterns, and environmental changes, the system can recommend real-time adjustments to the security infrastructure. This predictive capability ensures that the security system remains adaptive and responsive to evolving threats, changes in building layout, or operational modifications within the premises.

In addition to optimizing security sensor deployment, the LiDAR-based modeling approach enhances emergency response planning and facility management. The detailed 3D representation of interior spaces can be used to simulate emergency evacuation routes, track asset locations and management, and monitor high-risk zones in critical infrastructure settings, including government buildings, industrial plants, data centers, and high-security facilities.

In some embodiments, LiDAR scanning may also be deployed in real time through the use of mobile scanning units or aerial drones, enabling rapid security assessments and automated security audits of large-scale facilities. These real-time scans can be used to update security blueprints dynamically, ensuring that any modifications to the premises-such as new construction, renovations, or layout changes—are reflected in the security system design.

The combination of LiDAR technology, AI-driven sensor optimization, and 3D environmental modeling creates a next-generation security planning system that significantly reduces installation errors, post-installation modifications, and security vulnerabilities. Facilitated by model 400, system 100 eliminates manual placement guesswork and leverages real-world spatial intelligence, and ensures high-precision sensor deployment, regulatory compliance, and cost-effective security infrastructure management.

Advantageously, system 100 is capable of detecting obstacles such as furniture, partitions, or machinery that could obstruct a sensor's field of view, as demonstrated by locker stand 402. The system automatically flags areas with potential sensor interference, allowing security planners to relocate or adjust sensors to maximize effectiveness.

The LiDAR-generated model incorporates AI-driven analytics to simulate lighting conditions, personnel traffic, and intrusion scenarios, ensuring that security system placement is optimized for real-world conditions. In some embodiments, the system can overlay real-time security feeds within the digital model, providing facility managers with a fully interactive, AI-enhanced security dashboard.

Referring back to FIG. 1 in conjunction with FIGS. 2-4, in some embodiments, system 100 may include user devices and or display device. Such user device or display device (e.g. 610) may include an extended reality (XR) headset. Such XR headset provides an immersive, interactive method for visualizing, analyzing, and optimizing security system design before physical installation. By integrating XR with the automated sensor placement and configuration system, customers, security designers, and system integrators can navigate a fully simulated 3D BIM of the premises, gaining real-time insights into surveillance coverage, potential blind spots, and field-of-view obstructions. This advanced visualization capability allows users to move virtually through the environment, experiencing sensor placements as they would appear in reality, rather than relying on static diagrams or blueprint overlays. Within this dynamic space, users can explore different perspectives, test sensor angles, and adjust configurations to ensure complete coverage and optimal performance.

The XR headset enhances security planning by allowing users to position themselves at critical locations such as facility entrances, perimeters, and access points. As they navigate through the simulated environment, they can assess how security sensors respond to various conditions, including changes in lighting, weather, and potential physical obstructions. By engaging with the virtual model, users can evaluate whether cameras effectively capture individuals entering or exiting a premises, verify that no unexpected blind spots remain undetected, and adjust sensor heights or angles to mitigate obstacles caused by fencing, walls, or structural barriers. The system also enables real-time intrusion simulations, allowing users to experience how security systems respond to different breach attempts, movement patterns, and unauthorized access scenarios.

One of the most significant advantages of XR integration in security planning is its ability to prevent costly post-installation adjustments. Security system deployment frequently involves installing large, permanent infrastructure components such as poles for elevated camera mounting. Relocating these elements after installation is often logistically difficult and financially prohibitive. The XR simulation enables security teams to make precise placement decisions before committing to physical installations, significantly reducing the risk of later modifications. Users can determine whether cameras mounted at specific heights provide optimal coverage, whether additional sensors are required to address gaps, or whether changes in field of view would improve detection capabilities.

By incorporating LiDAR-generated three-dimensional models into the XR experience, the system ensures that security planners are working with an accurate digital twin of the facility. This integration allows them to verify that sensor placements align with real-world spatial constraints, providing a high level of confidence in the proposed security layout. The system dynamically detects clashes between sensor fields and physical obstructions, allowing users to modify configurations within the virtual environment before finalizing installation plans. The ability to overlay sensor placements onto existing BIM further enhances this process, ensuring that security systems are designed in harmony with architectural and operational considerations.

Additionally, the XR system enhances collaboration between stakeholders involved in the security design process. Clients, security professionals, and system integrators can collectively review and refine security plans within the immersive environment, making informed decisions about sensor configurations, monitoring capabilities, and potential system enhancements. This capability eliminates the need for multiple site visits and extensive physical prototyping, accelerating the overall deployment timeline while improving accuracy and efficiency.

Through the integration of XR technology with AI-driven sensor placement algorithms, the system continuously refines security configurations based on historical breach data, predictive analytics, and environmental changes. By simulating different security scenarios, the XR headset enables users to anticipate and address vulnerabilities before installation, creating a security infrastructure that is adaptive, responsive, and highly effective. This advanced visualization system represents a significant evolution in security planning, transforming it from a static, manual process into a dynamic, data-driven methodology that optimizes performance, minimizes costs, and enhances situational awareness in real-world applications.

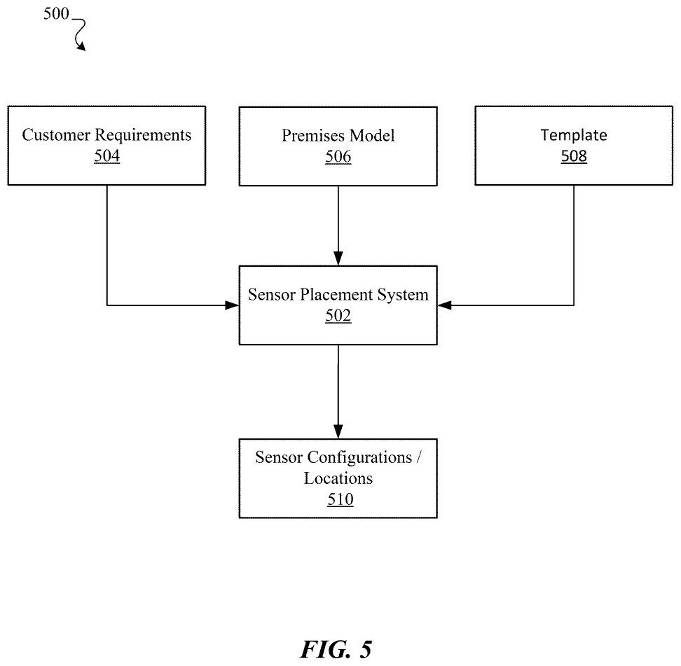

Referring now to FIG. 5, FIG. 5 is a block diagram representing the inputs and outputs for the sensor placement system 502, which is the core AI-driven system responsible for designing and optimizing sensor placements within a security environment. Customer Requirements 504 defines the security needs, such as coverage areas, budget constraints, priority zones, and detection thresholds. Premises Model 506 includes a 3D BIM representation of a physical site, created using LiDAR scans, blueprints, or aerial mapping, incorporating physical structures, terrain features, and obstructions. Template 508 may include a standardized repository of pre-configured sensor setups, coverage specifications, and compliance guidelines, ensuring adherence to best practices and regulatory standards. Sensor Placement System 502 includes AI-powered decision-making systems that processes the above inputs, applies machine learning algorithms, neural networks, and predictive analytics, and determines the optimal placement, orientation, and configuration of sensors. In some embodiments, sensor Configurations/Locations 510 is the final optimized sensor deployment plan, which output as visual reports, 3D models, 3D BIM models, and installation schematics, ready for implementation.

FIG. 5 illustrates workflow 500 which depicts how the sensor placement system 502 integrates data-driven automation, AI optimization, and real-world security constraints to create an efficient, intelligent, and adaptive security design. For example, the sensor placement system 502 operates as the central intelligence hub responsible for designing and optimizing the placement of security sensors within a customer's premises. This system is powered by AI-driven automation and is configured to process and analyze multiple inputs, including customer requirements 504, premises model 506, and template 508, to generate optimized sensor configurations and placement locations 510.

In some embodiments, the customer requirements 504 serve as the primary input criteria, detailing specific security needs such as coverage areas, detection thresholds, priority surveillance zones, and budget constraints. These requirements may vary widely depending on the nature of the premises, whether it is a commercial facility, an industrial site, a government building, or a critical infrastructure location. Customers may specify high-risk areas, such as entry and exit points, perimeter boundaries, or high-value asset locations, which require specialized sensor placement strategies.

In some embodiments, the premises model 506 provides a detailed three-dimensional (3D) representation of the physical environment where the security system will be deployed. This model is constructed using LiDAR scans, blueprints, or aerial mapping technologies and incorporates external terrain features, structural elements, and any potential obstructions that may impact sensor fields of view. The premises model ensures that sensor placement decisions account for real-world spatial constraints, optimizing surveillance coverage while minimizing blind spots and redundancy.

In some embodiments, template 508 acts as a predefined repository of standardized security configurations, sensor specifications, and deployment strategies. This template may include pre-configured sensor stands, coverage parameters, and compliance guidelines based on industry regulations and best practices. In some embodiments, template 508 is dynamically updated to reflect the latest advancements in surveillance technology, regulatory compliance standards, and cost-optimized security configurations.

In some embodiments, sensor placement system 502 leverages machine learning algorithms and neural networks to analyze, refine, and optimize sensor deployment based on the provided inputs. The system applies predictive analytics and historical data to determine optimal sensor positions, angles, and coverage areas, ensuring maximum efficiency with minimal infrastructure costs. In some embodiments by incorporating convolutional neural networks (CNNs) and deep learning models, the system can recognize patterns in security threats, adjust sensor configurations dynamically, and continuously improve surveillance performance over time.

Once the sensor placement system 502 processes the inputs, it outputs a detailed sensor configuration and placement plan 510. This output includes precise locations, orientations, and coverage zones for each sensor, ensuring that the system meets both customer-defined security objectives and automated optimization criteria. The configuration data is formatted into visual reports, 3D BIM models, and installation schematics, providing security professionals with a clear, actionable deployment plan.

In some embodiments, the sensor placement system 502 is capable of real-time recalibration, allowing security teams to adjust configurations based on changing security threats, environmental conditions, or operational requirements. The system may also integrate with augmented reality (AR) or extended reality (XR) visualization tools, enabling users to simulate sensor performance in a virtualized environment before physical installation.

Furthermore, in some embodiments, the sensor placement system 502 incorporates predictive maintenance tracking and lifecycle management capabilities, ensuring that deployed sensors remain operationally efficient over time. The system can monitor sensor health, detect potential failures, and schedule proactive maintenance activities, reducing the risk of security lapses due to sensor malfunctions or environmental degradation.

By integrating AI-driven automation, real-time spatial analytics, and predictive modeling, FIG. 5 illustrates how the sensor placement system 502 serves as a comprehensive, intelligent security planning tool that enhances efficiency, accuracy, and adaptability in modern physical security system design.

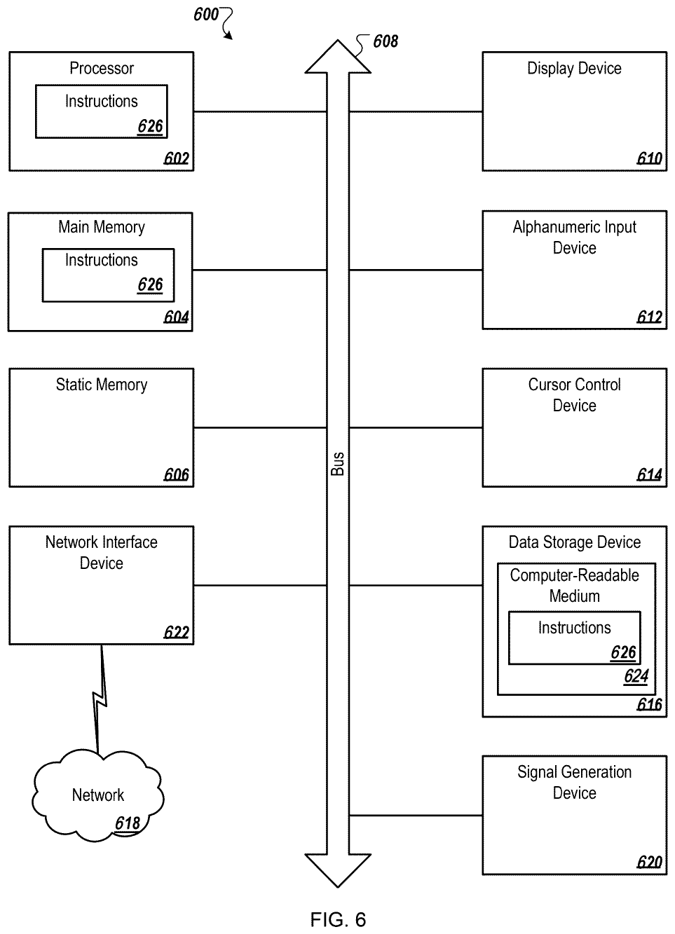

Referring now to FIG. 6, illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in a client-server network environment. Further, while only a single machine is illustrated, the term “machine” may also include any collection of machines that individually or jointly execute a set (or multiple sets) of instructions to perform any one or more of the methods discussed herein.

In some embodiments, device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

In some embodiments, processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application-specific integrated circuit (ASIC), a field-programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker). In at least one example, the display device 610, the alphanumeric input device 612, and the cursor control device 614 may be combined into a single component or device (e.g., an LCD touch screen). In some embodiments, display device 610 may include an AR headset.

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding, or carrying a set of instructions for execution by the machine and that cause the machine to perform any one or more of the methods of the present disclosure. The term “computer-readable storage medium” may accordingly be taken to include, but not be limited to, solid-state memories, optical media, and magnetic media.

Thus, the system and method for sensor placement, configuration, and tracking discussed above provide an automated, intelligent, and highly adaptable approach to physical security system design. By leveraging advanced 3D mapping techniques (e.g., 3D BIM), LiDAR-based spatial modeling, machine learning-driven optimization, and extended reality (XR) visualization, the system ensures that security deployments are comprehensive, cost-effective, and tailored to specific customer requirements.

The sensor placement system integrates multiple data sources, including customer requirements, premises models, and pre-configured security templates, to create an optimized surveillance layout that maximizes coverage while minimizing redundancy and costs. The use of artificial intelligence (AI), convolutional neural networks (CNNs), and predictive analytics enhances the system's ability to dynamically adjust sensor configurations in response to environmental changes, threat patterns, and operational requirements.

The ability to simulate, refine, and validate security system designs in a virtualized environment significantly reduces the risk of costly post-installation modifications, ensuring that physical infrastructure, such as sensor stands and mounting structures, are optimally positioned before implementation. Additionally, by integrating real-time sensor health monitoring and predictive maintenance tracking, the system extends the operational lifespan of security installations, reducing long-term costs and improving overall system reliability.

Through the combination of automated security planning, AI-driven optimization, and immersive visualization, this system represents a paradigm shift in modern security system design and deployment. It enables security providers, architects, and system integrators to achieve higher levels of efficiency, precision, and adaptability, ensuring that security installations remain effective, scalable, and resilient against evolving threats.

Accordingly, the embodiments described above advances the state of the art in security system automation, providing a solution that enhances safety, reduces human error, and streamlines the deployment process. The features described herein are not limited to the embodiments explicitly discussed but encompass all variations and equivalents falling within the scope of the appended claims.

The embodiments described herein may be embodied in systems, apparatus, methods, computer programs, and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and sub-combinations of the disclosed features and/or combinations and sub-combinations of further features noted above. Furthermore, above-described advantages are not intended to limit the application of any issued claims to processes and structures accomplishing any or all of the advantages. Furthermore, any reference to this disclosure in general or use of the word “embodiment” in the singular is not intended to imply any limitation on the scope of the claims set forth below. Multiple embodiments may be set forth according to the limitations of the multiple claims issuing from this disclosure, and such claims accordingly define the embodiment(s) herein, and their equivalents, that are protected thereby.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

Furthermore, any reference to this disclosure in general or use of the word “embodiment” in the singular is not intended to imply any limitation on the scope of the claims set forth below. Multiple embodiments may be set forth according to the limitations of the multiple claims issuing from this disclosure, and such claims accordingly define the embodiment(s) herein, and their equivalents, that are protected thereby.

What is claimed is:

1. A method for automated sensor placement and configuration, comprising:
receiving a three-dimensional model of a customer premises, the model generated at least in part by one or more non-imaging sensors;
receiving premises coverage requirements including one or more: surveillance objectives, security constraints, and/or designated monitoring zones;
determining a plurality of sensor models within the three-dimensional model of the customer premises based on environmental obstructions, detection coverage, and/or redundancy minimization;
outputting, a visualization corresponding to sensor coverage, based on the plurality of sensor models, within the three-dimensional model to identify blind spots, overlaps, and potential security vulnerabilities; and
generating a deployment report comprising sensor placement locations, orientations, and operational parameters relative to the customer premises.

2. The method of claim 1, wherein the three-dimensional model of the customer premises is generated using a combination of LiDAR scanning, time-of-flight sensors, stereo vision cameras, or blueprint-based parametric modeling.

3. The method of claim 1, further comprising:
determining a predefined security configuration template comprising sensor placement strategies for different surveillance environments;
adjusting the sensor deployment strategy based on at least one of customer-defined security preferences, regulatory compliance requirements, or environmental constraints; and
adjusting sensor placements dynamically based on AI-driven predictive analytics that simulate real-world intrusion scenarios.

4. The method of claim 1, wherein the step of simulating and visualizing sensor coverage further comprises:
rendering an extended reality (XR) environment in which a user can navigate the customer premises virtually and interact with sensor coverage zones;
adjusting sensor placements in real-time within the XR interface to optimize field-of-view configurations; and
displaying AI-generated alerts identifying obstructions, security gaps, or misalignments before physical installation.

5. The method of claim 1, further comprising:
detecting existing security infrastructure, including surveillance devices, access control systems, and intrusion detection units, using automated object recognition;
mapping detected security infrastructure to the three-dimensional premises model; and
generating a comparative analysis report that identifies gaps in security coverage based on the existing infrastructure.

6. The method of claim 1, wherein the deployment report further comprises:
rendering multi-angle perspective views of sensor coverage, including top-down, side, and/or three-dimensional renderings;
environmental impact analysis indicating how lighting conditions, terrain variations, and architectural structures affect sensor performance; and
a cost estimate for sensor placement configurations based on predefined budgetary constraints and cost-optimization algorithms.

7. The method of claim 1, further comprising:
determining anomalies or security threats via real-time sensor health monitoring by linking deployed sensors to a cloud-based predictive maintenance platform;
continuously analyzing sensor functionality, performance degradation, and environmental interferences; and
triggering automated recalibration or reconfiguration of sensor placements based on determining the anomalies or security threats.

8. A system for automated sensor placement and configuration, comprising:
a non-imaging sensor array configured to generate a three-dimensional model of a customer premises, the array comprising at least one of a LIDAR scanner, time-of-flight sensor, or stereo vision camera;
a data processing module configured to receive premises coverage requirements specifying surveillance objectives, security constraints, and designated monitoring zones;
a sensor placement engine configured to autonomously distribute a plurality of sensor models within the three-dimensional model of the customer premises based on an optimization algorithm that accounts for environmental obstructions, detection coverage, and redundancy minimization;
a visualization module configured to simulate and render sensor coverage within the three-dimensional model to identify blind spots, overlaps, and potential security vulnerabilities; and
a report generation module configured to produce a deployment report comprising sensor placement locations, orientations, and operational parameters relative to the customer premises.

9. The system of claim 8, wherein the non-imaging sensor array is further configured to generate the three-dimensional model of the customer premises using a combination of LiDAR scanning, blueprint-based parametric modeling, and aerial mapping data.

10. The system of claim 8, further comprising:
a security configuration database storing predefined security templates comprising sensor placement strategies for different surveillance environments;
a customization engine configured to modify sensor deployment strategies based on at least one of customer-defined security preferences, regulatory compliance requirements, or environmental constraints; and
an AI-driven analytics module configured to dynamically adjust sensor placements by simulating real-world intrusion scenarios and optimizing field-of-view configurations.

11. The system of claim 8, wherein the visualization module further comprises:
an extended reality (XR) display device configured to allow a user to navigate the customer premises virtually and interact with sensor coverage zones;
a real-time adjustment module that enables modification of sensor placements directly within the XR environment; and
an AI-based alert system that generates notifications identifying obstructions, security gaps, or misaligned sensors before physical installation.

12. The system of claim 8, further comprising:
an automated object recognition module configured to detect existing security infrastructure, including surveillance devices, access control systems, and intrusion detection units;
an integration module configured to map detected security infrastructure to the three-dimensional premises model; and
a comparative analysis module configured to generate a security gap report based on the existing infrastructure.

13. The system of claim 8, wherein the report generation module further comprises:
a multi-angle rendering engine configured to generate sensor coverage visualizations, including top-down, side, and three-dimensional perspective views;
an environmental analysis module configured to assess lighting conditions, terrain variations, and architectural structures affecting sensor performance; and
a cost estimation engine configured to generate sensor placement configurations that adhere to predefined budgetary constraints using cost-optimization algorithms.

14. The system of claim 8, further comprising:
a predictive maintenance platform configured to integrate real-time sensor health monitoring with cloud-based analytics;
a sensor diagnostics module configured to detect performance degradation, environmental interferences, and potential security risks; and
an automated recalibration engine configured to adjust sensor placements and operational settings dynamically based on detected anomalies or evolving security threats.

15. A sensor stand for a physical security system, comprising:
a support structure configured to mount a plurality of security sensors at a predefined height and orientation;
at least one surveillance camera configured to capture video data within a predetermined field of view;
at least one motion detection sensor configured to detect movement within a monitored area;
an infrared (IR) illuminator configured to enhance low-light visibility for night-time surveillance; and
a communication module configured to transmit sensor data and detection events to a system server for processing, analysis, and adaptive security response.

16. The sensor stand of claim 15, wherein the communication module is further configured to:
establish a real-time data link with the system server over a wireless or wired network;
transmit detected motion, video feeds, and environmental data to the system server for AI-driven analysis; and
receive optimization instructions from the system server to dynamically adjust camera angles, sensor sensitivity, or IR illumination intensity.

17. The sensor stand of claim 15, further comprising:
a sensor calibration unit configured to periodically self-adjust sensor positioning based on feedback received from the system server;
a clash detection module configured to identify and mitigate sensor interference caused by environmental obstructions; and
an automated realignment mechanism configured to fine-tune sensor orientation based on real-time threat assessment from the system server.

18. The sensor stand of claim 15, wherein the surveillance camera is further configured to:
capture multi-angle imagery and transmit it to the system server for three-dimensional premises modeling;
operate in conjunction with at least one LiDAR sensor to assist in generating a real-time 3D representation of the monitored environment; and
perform adaptive zoom and tracking in response to detected security events, as commanded by the system server.

19. The sensor stand of claim 15, wherein the motion detection sensor is further configured to:
differentiate between human movement, vehicular activity, and non-threat environmental motion using AI-based filtering within the system server;
trigger an immediate security alert to the system server upon detecting unauthorized activity; and
initiate an automated system response, such as activating floodlights, sounding an alarm, or alerting on-site security personnel.

20. The sensor stand of claim 15, wherein the communication module is further configured to:
continuously relay sensor diagnostics and operational status to the system server for predictive maintenance analysis;
detect sensor degradation or tampering and report such anomalies to the system server; and
synchronize with an extended reality (XR) interface within the system server to allow users to visualize real-time sensor coverage, adjust configurations, and simulate security events.
